(19) United States
(12) Patent Application Publication
(10) Pub. No.: US 2018/0366018 A1
(43) Pub. Date: Dec. 20, 2018

(54) CONFERENCE SYSTEM FOR THE TRAINING OF INTERPRETERS

(71) Applicant: TELEVIC EDUCATION NV, Izegem (BE)

(72) Inventors: Sylvie VENANT, Wervik (BE); Xavier DE DONDER, Izegem (BE); Sven CALLEWAERT, Torhout (BE)

(73) Assignee: TELEVIC EDUCATION NV, Izegem (BE)

(21) Appl. No.: 16/062,730

(22) PCT Filed: Dec. 22, 2016
(86) PCT No.: PCT/BE2016/000052

§ 371 Date: Jun. 15, 2018

(30) Foreign Application Priority Data
Dec. 22, 2015 (BE) 2015/5839

(51) Int. Cl. G09B 5/12; G09B 19/04; G09B 5/06

(52) U.S. Cl. CPC G09B 5/12; G09B 5/065; G09B 19/04

(57) ABSTRACT

The invention relates to a conference system, suitable for the training of interpreters, which conference system comprises: a central unit, a chairman's unit, a plurality of participant units, and a plurality of interpreter units; a teacher unit associated with the chairman's unit; and trainee units associated with the respective plurality of interpreter units; wherein the chairman's unit, the plurality of participant units and the plurality of interpreter units are connected to the central unit by means of a first digital network.

The present invention relates to a conference system, suitable for the training of interpreters.

A conference system which allows communication between a chairman and participants of a conference, and which at the same time makes simultaneous translation by interpreters possible, is known, inter alia, from European patent application no. EP 2 924 984 A1 in the name of the present Applicant. Similar systems are in use in the European Parliament in Brussels, the European Commission in Brussels, the United Nations in Geneva, and numerous other organizations. The conference system comprises, inter alia, a central unit, a chairman's unit, a plurality of participant units, and a plurality of interpreter units. The conference system can be made suitable for the training of interpreters, by means of a teacher unit associated with the chairman's unit and trainee units associated with the respective plurality of interpreter units; customized systems of this type are today already known, including the “Avidanet® Interpreter training system” of the present Applicant. The chairman's unit, the plurality of participant units and the plurality of interpreter units are connected to the central unit by means of a first digital network. The central unit is configured to, in an operating mode, allow distribution of: a first set of audio signals from the chairman's unit to selected participant units and selected interpreter units; a second set of audio signals from selected participant units to selected other participant units, selected interpreter units and the chairman's unit; and a third set of audio signals from selected interpreter units to selected other interpreter units, selected participant units and the chairman's unit.

It is a drawback of the known system that, relative to traditional conference systems, complex additional analog audio cabling is necessary to enable the functionality which is required for training. Once this cabling has been laid, it is impossible to implement additional functions which have not previously been foreseen.

The aforementioned problem is solved by a conference system of the above type, in which the teacher unit and the trainee units are connected to the central unit by means of a second digital network.

The teacher unit and the trainee units are associated with the respective chairman's unit and interpreter units in the sense that they are respectively installed at one and the same location. In this way, a teacher or tutor can operate from his workplace (for example the chairman's seat) both his chairman's unit and the associated teacher unit; similarly, each trainee or student can operate from his workplace (for example in an interpreter booth) both his interpreter unit and the associated trainee unit. The chairman's unit and the interpreter units are locally not necessarily connected to their respective associated teacher unit and trainee units; the necessary functional interaction between the two is made possible by the fact that each of the two elements is respectively connected to the central unit, by means of respectively the first and the second digital network. The central unit thus forms a sort of matrix, which enables interconnection between the first and the second digital network.

In one embodiment of the conference system according to the invention, the teacher unit is configured to dispatch pre-recorded speech, and the central unit is further configured to, in a training mode, allow distribution of the pre-recorded speech, as a fourth set of audio signals, from the teacher unit to the selected interpreter units.

It is an advantage of this embodiment that a centralized distribution of audio from the teacher unit to various interpreter units and participant units is possible. In an interpreter training context, that is to say that the tutor can send or stream the files containing auditory tasks from his unit to the respective interpreter units, so that the trainees can practice (or be tested) on the basis of these tasks.

The distribution to the respective selected interpreter units preferably takes place simultaneously, so that a plurality of students can carry out the same exercise, or can take the same exam, at the same time.

Optionally, the pre-recorded speech at the teacher unit, in the training mode, is forwarded by the central unit not only to the selected interpreter units, but also to selected participant units. This enables observers (for example other students or tutors) to passively follow the simultaneous translation exercise. Furthermore, the pre-recorded speech, in the training mode, can be forwarded by the central unit also to the chairman's unit, in order to allow the tutor to, from there, check the played-back task and evaluate the exercise.

In one embodiment of the conference system according to the invention, the trainee units are configured to dispatch pre-recorded speech, and the central unit is further configured to, in a training mode, allow distribution of the pre-recorded speech, as a fourth set of audio signals, from the trainee units to the respective associated interpreter units.

It is an advantage of this embodiment that a distribution of pre-recorded audio at the trainee unit to the associated interpreter unit is possible. In an interpreter training context, this is to say that the student can send or stream the files containing auditory tasks from his unit to his associated interpreter unit, so that the student can practice independently (or test himself) on the basis of these tasks.

Optionally, the pre-recorded speech at the trainee unit, in the training mode, is forwarded by the central unit not only to the relevant interpreter unit, but also to selected participant units. This makes it possible for observers (for example other students or tutors) to passively follow the simultaneous translation exercise. Furthermore, the pre-recorded speech, in the training mode, can be forwarded by the central unit also to the chairman's unit, in order to allow the tutor to, from there, check the played-back task and evaluate the exercise.

In one embodiment of the conference system according to the invention, the central unit is further configured to, in a training mode, allow distribution of locally captured speech signals, as a fifth set of audio signals, from the interpreter units to the respective associated trainee units, and the trainee units, furthermore, are provided with recording means to record the pre-recorded speech, together with the speech signal captured locally at the associated interpreter unit.

It is an advantage of this embodiment that the result of the exercise or test of each trainee is recorded in the trainee unit of this trainee, together with the pre-recorded audio which has been played back to serve as the task, in order to subsequently allow an evaluation.

In one embodiment of the present invention, the central unit is further configured to, in a training mode, allow distribution of a speech signal captured by the chairman's unit or by a participant unit, as a fourth set of audio signals, to selected trainee units; if the central unit is further configured to, in the training mode, allow distribution of locally captured speech signals, as a fifth set of audio signals, from the interpreter units to the respective associated trainee units; and the trainee units, furthermore, are provided with recording means to record the speech signal captured by the chairman's unit or by the participant unit, together with the speech signal captured locally at the associated interpreter unit.

It is an advantage of this embodiment that the result of the exercise or test of each trainee is recorded in the trainee unit of this trainee, together with the text spoken by the chairman or by a participant, which serves as the task, in order to subsequently allow an evaluation.

In one specific embodiment, the conference system is further provided with cameras associated with the trainee units, and the recording means are configured to record, at at least one of the trainee units, a video signal, together with a speech signal captured locally at the associated interpreter unit.

It is an advantage of this embodiment that visual information on the proper conduct of an exercise or test can be gathered, and recorded together with the task and the speech of the trainee.

In one embodiment of the conference system according to the invention, the central unit is further configured to, in a training mode, allow distribution of pre-recorded speech, dispatched by the teacher unit or by a trainee unit, as a fourth set of audio signals, to selected interpreter units; the central unit is further configured to, in the training mode, allow distribution of locally captured speech signals, as a fifth set of audio signals, from the interpreter units to the teacher unit; and the teacher unit, furthermore, is provided with recording means to record the pre-recorded speech, together with the speech signals captured locally by respective interpreter units.

It is an advantage of this embodiment that the tutor can subsequently evaluate the conduct of the exercise or test, by recording the audio signal which is sent back from the trainee units. The tutor has the possibility of recording the task (fourth set of signals) and the speech of the trainee (fifth set of signals) in a synchronized manner, so that these can subsequently be listened to simultaneously.

According to one aspect of the present invention, a computer program product is provided, comprising code means which are configured to, in a central unit, provide the distribution of the sets of signals as described above.

These and other technical effects and advantages of embodiments of the present invention will now be explained in greater detail with reference to the appended figures, in which:

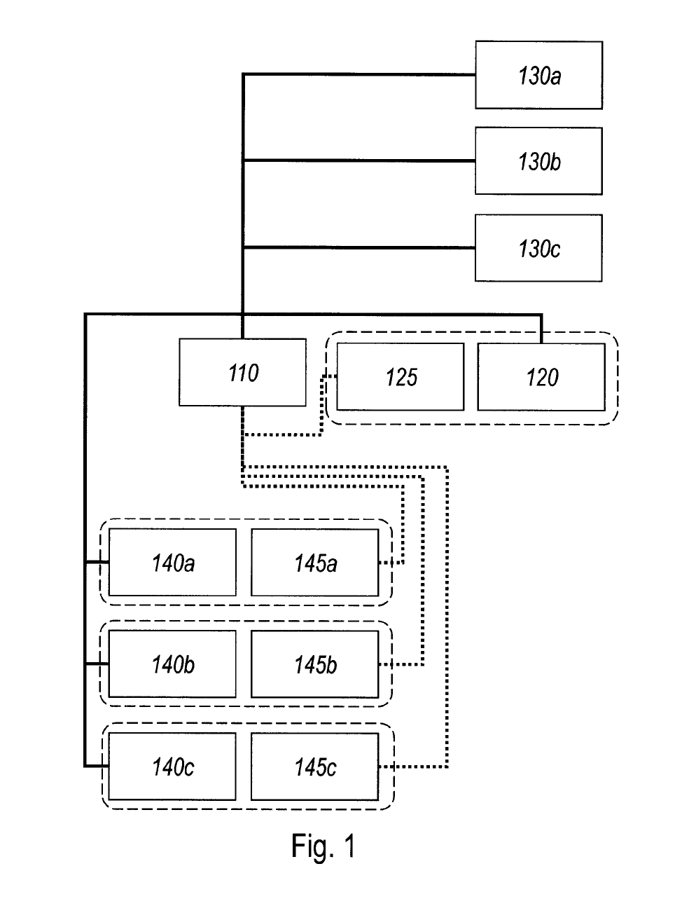

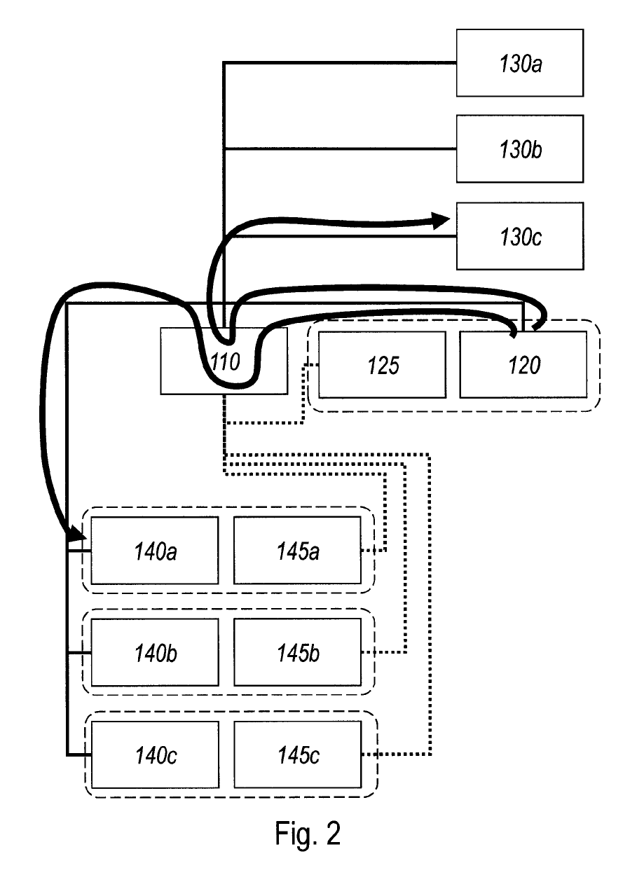

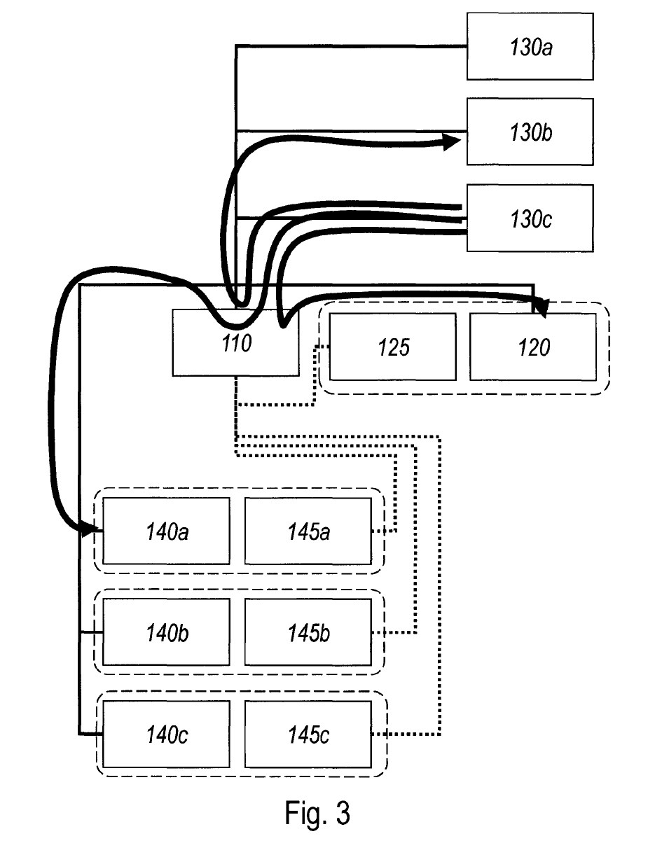

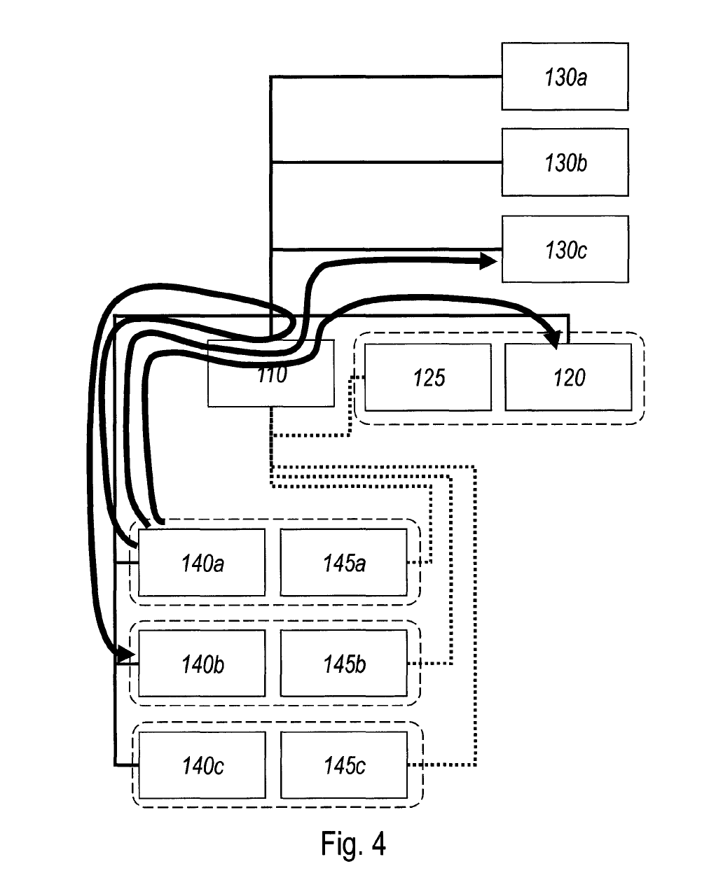

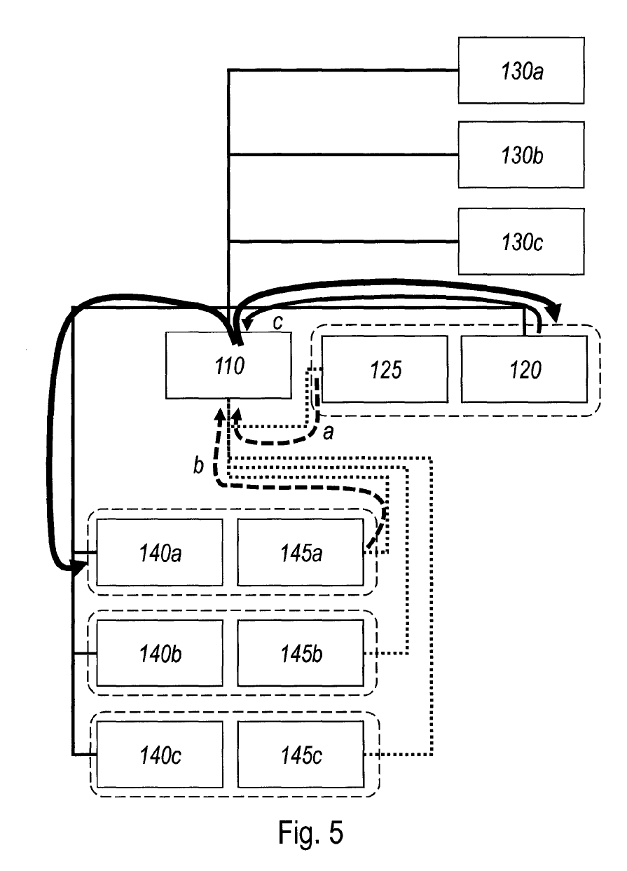

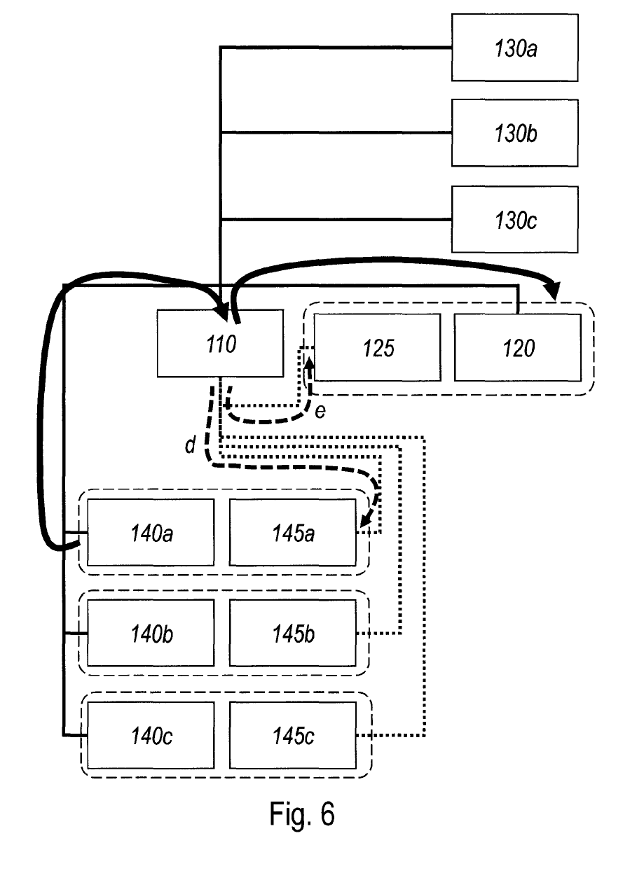

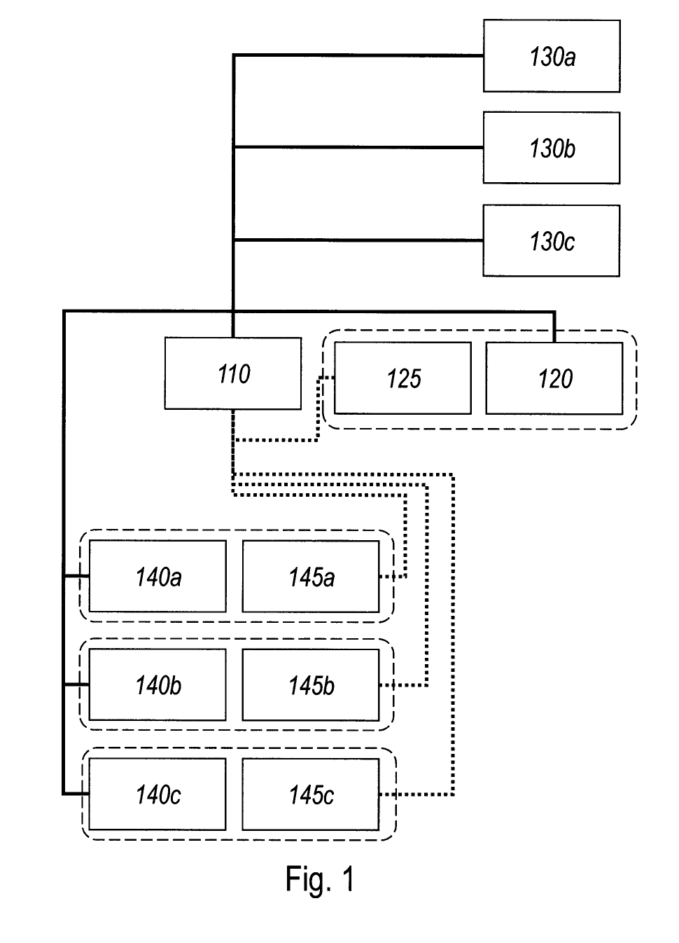

FIG. 1 presents an overview of a system architecture for a conference system according to one embodiment of the present invention;

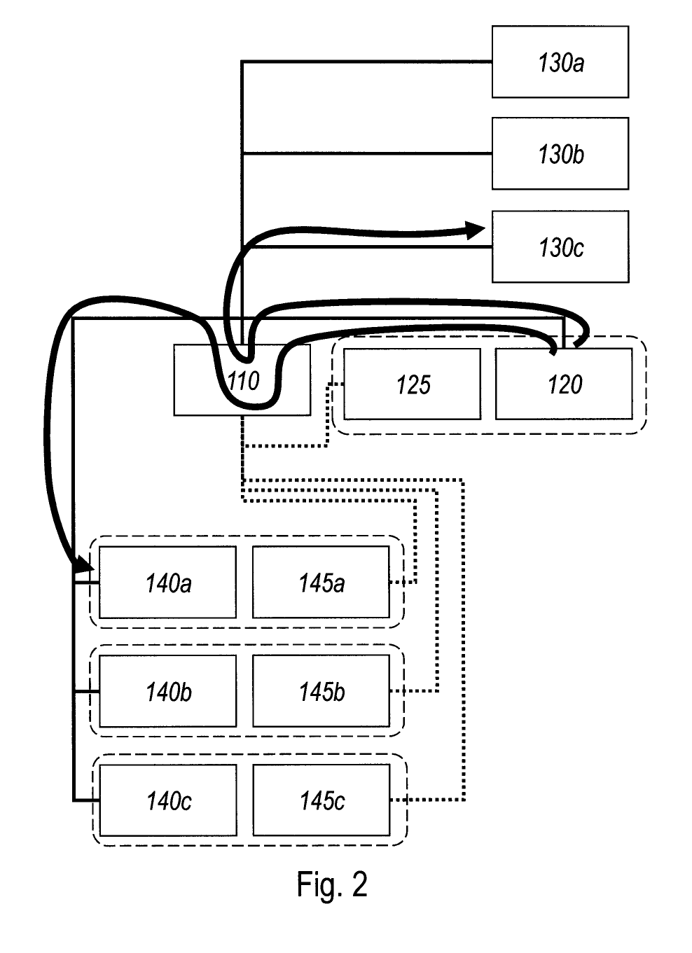

FIG. 2 schematically represents a first set of signals in the system of FIG. 1;

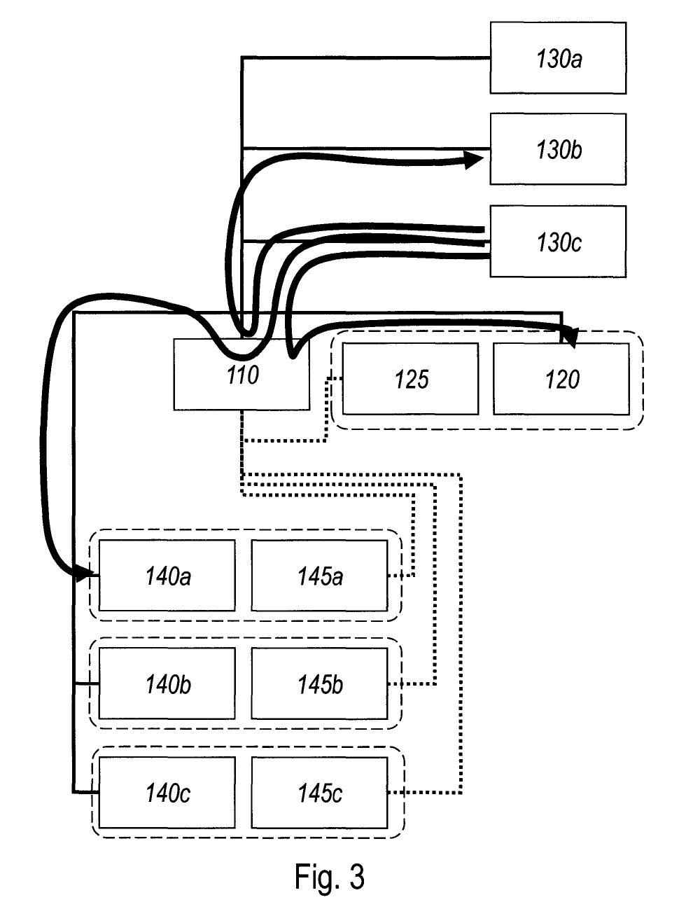

FIG. 3 schematically represents a second set of signals in the system of FIG. 1;

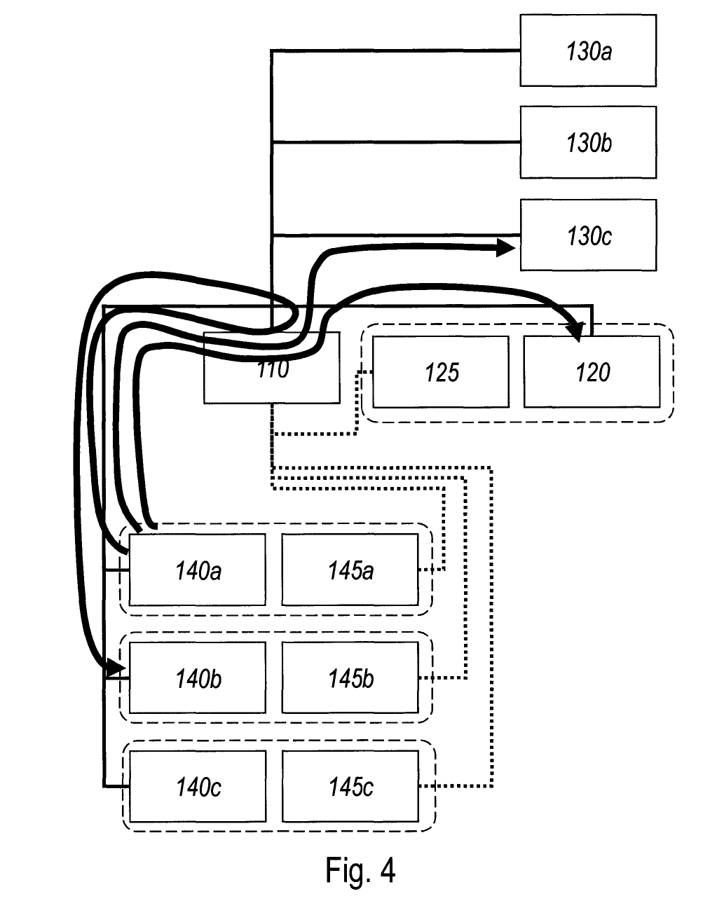

FIG. 4 schematically represents a third set of signals in the system of FIG. 1;

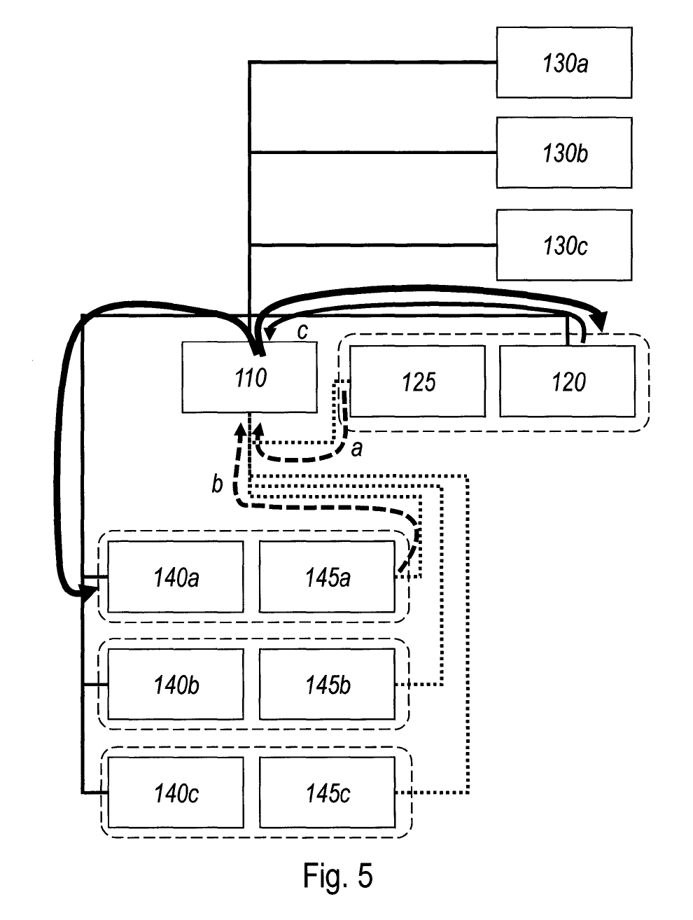

FIG. 5 schematically represents a fourth set of signals in the system of FIG. 1; and

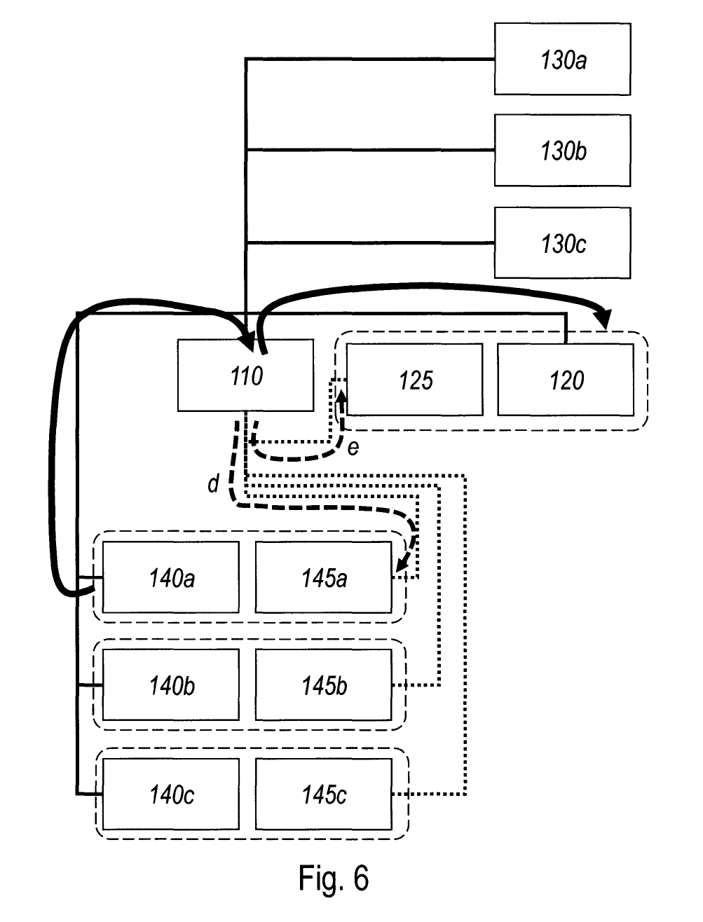

FIG. 6 schematically represents a fifth set of signals in the system of FIG. 1.

FIG. 1 presents a schematic overview of a system architecture for a conference system according to one embodiment of the present invention. A central unit 110 is responsible for forwarding the various signals between the connected chairman's unit 120, participant units 130a-c, and interpreter units 140a-c. Without loss of generality, in the illustrated case three participant units 130a-c and three interpreter units 140a-c are represented; it will be readily clear to the person skilled in the art that these can be more or fewer in number.

The chairman's unit 110, the participant units 130a-c and the interpreter units 140a-c are connected to the central unit 110 by means of a first digital network, represented in solid lines in the figures (any bridges, switches and routers which would be necessary for the functioning of the network are not represented separately).

The normal working of the conference system in its “operating mode” (outside the training context) is characterized by three signal streams, which can be realized through the agency of the central unit 110:
FIG. 2 schematically represents a first set of audio signals, from the chairman's unit 120 to selected participant units 130c and selected interpreter units 140a; this is to say that the participants and the interpreters can hear the chairman speak.
FIG. 3 schematically represents a second set of audio signals, from selected participant units 130c to selected other participant units 130b, selected interpreter units 140a and the chairman's unit 120; this is to say that the interpreters can hear the participants, that participants can hear one another speak, and that the chairman can hear the participants.
FIG. 4 schematically represents a third set of audio signals, from selected interpreter units 140a to selected other interpreter units 140b, selected participant units 130c and the chairman's unit 120; this is to say that the chairman, the participants and interpreters, in relay mode, can hear the interpreters speak.

The signals, which in an “operating mode” can be forwarded, can serve as a task for an exercise or a test for the benefit of students. In particular, the exercise or test can consist in the students, via their interpreter unit 140a, listening to a task which is recorded by the tutor via the chairman's unit 120 or is played back via a possible audio input of the chairman's unit 120 (first set of audio signals), and simultaneously translate these via the interpreter unit 140a, wherein the tutor can listen to the translation via his chairman's unit 120 (third set of audio signals).

The additional training facilities (in particular the centralized or distributed recording and/or playback of tasks) are made possible by the trainee units 145a-c and the teacher unit 125, which are connected to the central unit 110 via a second digital network, represented in dotted lines in the figures (any bridges, switches and routers which would be necessary for the functioning of the network are not represented separately). The required extra functionality of the central unit 110 is herein designated as the training mode.

The teacher unit 125 comprises at least the functionality of data storage (for example a hard disk, in order to be able to store a digital audio file) and the playback of audio (for example from an audio file stored on the hard disk). The teacher unit 125 comprises, in principle, no microphone or headphone of its own, but is associated with a chairman's unit 120 which does have this, optionally in the form of a headset (microphone-headphone combination). The teacher unit 125 preferably comprises a simple user interface, for example a combination of a screen and a keyboard and/or mouse (this can be the case if the teacher unit is PC-based) or a touch screen (this can be the case if the teacher unit is tablet-based); with this, an audio file which is to be played back or recorded can preferably be selected.

The trainee unit 145a-c comprises at least the functionality of data storage (for example a hard disk, in order to be able to store a digital audio file) and the playback of audio (for example from an audio file stored on the hard disk). Optionally, the trainee unit 145a-c also comprises a webcam. The trainee unit 145a-c comprises, in principle, no microphone or headphone of its own, but is associated with an interpreter unit 140a-c which does have this, optionally in the form of a headset (microphone-headphone combination). The trainee unit 145a-c preferably comprises a simple user interface, for example a combination of a screen and a keyboard and/or mouse (this can be the case if the trainee unit is PC-based) or a touch screen (this can be the case if the trainee unit is tablet-based); with this, an audio file which is to be played back or recorded can preferably be selected.

In some embodiments of the present invention, the trainee unit 145a-c can execute, inter alia, the following functions:
The giving of visual/textual instructions to the user (trainee);
The playback of a locally stored sound file, to be reproduced via the headphone or loudspeaker of the associated interpreter unit (the sound signal is then sent from the trainee unit via the second digital network to the central unit, whence it is forwarded via the first digital network to the associated interpreter unit);
The storage of a locally recorded speech file, to be captured via the microphone of the associated interpreter unit, optionally in combination with the recording of the played-back task (i.e. the abovementioned sound file, which is stored locally or in the teacher unit and which is reproduced to the trainee via the associated interpreter unit); optionally a locally recorded video signal is in this case additionally stored, to be captured via the optional webcam;
The dispatch (in particular to the chairman's unit) of said stored speech recording (optionally with the task and/or the video recording).

By in this way making use of interpreter units which form part of a traditional conference infrastructure, the practicing and testing of the interpreting skills can take place under conditions which approximate as closely as possible to professional reality.

The practicing and testing of interpreting skills is realized by reproducing a task (a spoken text in a source language according to choice) to the student, who translates this simultaneously, out loud, into a predefined target language. The spoken translation must be able to be listened to simultaneously and in synchronization with the task (directly or subsequently, by means of recording) for evaluation (self-evaluation and/or evaluation by the tutor). The system according to the present invention offers a maximum flexibility regarding the choice of where the task is stored and played back, and where the spoken translation is stored and listened to.

The audio to be listened to by the student (i.e. the exercise or task) reaches the relevant interpreter unit 140a via the first digital network as a fourth set of signals, as represented in FIG. 5 (solid arrow). This audio can derive from the teacher unit 125 (arrow in dotted line, with designation “a”), from the trainee unit 145a associated with the interpreter unit 140a (arrow in dotted line, with designation “b”), or from directly captured speech of a tutor who operates the chairman's unit 120 or a participant unit (solid arrow, with designation “c”).

In the first case (arrow “a” in FIG. 5), it is a question of central distribution of audio. The teacher unit 125 is then configured to store and dispatch pre-recorded speech. The central unit 110 is configured to allow distribution of the pre-recorded speech, from the teacher unit 125 to the selected interpreter unit 140a.

In the second case (arrow “b” in FIG. 5), the trainee unit 145a is configured to store and dispatch pre-recorded speech, so that the student himself can start the playback of the task. The central unit 110 is configured to allow distribution of the pre-recorded speech, from the trainee unit 145a to the interpreter unit 140a associated therewith.

In the third case (arrow “c” in FIG. 5), use is made of the first digital network to, as in the first operating mode, dispatch “live” captured speech from the chairman's unit 120 or a participant unit (not shown) to the selected interpreter unit 140a.

In the three cases, the task is preferably sent by the central unit 110 over the first digital network to the chairman's unit 120 in order to allow the tutor to listen to the task.

The text spoken by the student (i.e. the translation of the exercise or task) is captured by his interpreter unit 140a and dispatched away from there for storage as a fifth set of signals, as represented in FIG. 6 (solid arrow). This audio can be conveyed to the trainee unit 145a associated with the interpreter unit 140a (arrow in dotted line with designation “d”) or to the teacher unit 125 (arrow in dotted line with designation “e”).

In the first case (arrow “d” in FIG. 6), it is a question of distributed recording of audio. The trainee units are then provided with recording means in order to record the task (which is already available there in case “b” of FIG. 5, or which, if need be, is additionally received there via the route of arrow “d” in FIG. 6 if the task is dispatched according to case “a” or “c” of FIG. 5), together with a speech signal captured locally at said interpreter unit.

Optionally, the system is additionally provided with cameras associated with the trainee units 145a-c, and the recording means are configured to record, at at least one of the trainee units, a video signal, together with a speech signal, captured locally at the associated interpreter unit, and the task.

In the second case (arrow “e” in FIG. 6), it is a question of central recording of audio. The teacher unit is then provided with recording means to record the task (which is already available there in case “a” of FIG. 5, or which, if need be, is additionally received there via the route of arrow “e” in FIG. 6 if the task is dispatched according to case “b” or “c” of FIG. 5), together with a speech signal captured locally at the interpreter unit.

The text spoken by the student is in both cases preferably sent by the central unit 110 over the first digital network to the chairman's unit 120 in order to allow the tutor to listen to the speech.

The first and the second digital network are preferably networks which operate according to a generally accepted standard. At the level of the physical layer and the datalink layer, networks according to IEEE Std 802.3 (“Ethernet”) can be used, in particular 100 Mb/s, 1000 Mb/s or 10 Gb/s networks over suitable copper or glass fiber cabling. Wireless networks having a sufficiently high capacity, for example according to IEEE Std 802.11, can likewise be used. At the level of the network layer and transport layer, the Internet Protocol (IP) and User Datagram Protocol (UDP) can respectively be used. The central unit 110, the chairman's unit 120, the teacher unit 125, the participant units 130a-c, the interpreter units 140a-c, and the trainee units 145a-c, have for this purpose the required interfaces (at hardware and software level).

The above-described functions of the central unit 110 can be implemented in hardware components (e.g. ASICs) specifically designed for the purpose, configurable components (e.g. FPGA's), programmable components provided with suitable software (e.g. DSP's or processors for general purposes), or some combination of the above. The same components can also execute other functions.

The present invention also relates to a computer program product, comprising code means which are configured to, in a central unit 110, provide the distribution of the sets of signals as described above.

Although the invention above has been described with reference to specific embodiments, this is meant as illustration and not as limitation of the scope of protection, which is defined by the attached claims. Moreover, the functions which have been described as a component part of different embodiments can be combined with one another without departing from the principles and scope of the present invention.

1. A conference system, suitable for the training of interpreters, which conference system comprises:
a central unit,
a chairman's unit,
a plurality of participant units, and
a plurality of interpreter units;
a teacher unit associated with the chairman's unit; and
trainee units associated with the respective plurality of interpreter units;
wherein the chairman's unit, the plurality of participant units and the plurality of interpreter units are connected to the central unit by means of a first digital network; and
wherein the central unit is configured to, in an operating mode, allow distribution of:
a first set of audio signals from the chairman's unit to selected participant units and selected interpreter units;
a second set of audio signals from selected participant units to selected other participant units, selected interpreter units and the chairman's unit; and
a third set of audio signals from selected interpreter units to selected other interpreter units, selected participant units and the chairman's unit;
characterized in that the teacher unit and the trainee units are connected to the central unit by means of a second digital network.

2. The conference system as claimed in claim 1, wherein the teacher unit is configured to dispatch pre-recorded speech, and wherein the central unit is further configured to, in a training mode, allow distribution of the pre-recorded speech, as a fourth set of audio signals, from the teacher unit to selected interpreter units.

3. The conference system as claimed in claim 1, wherein the trainee units are configured to dispatch pre-recorded speech, and wherein the central unit is further configured to, in a training mode, allow distribution of the pre-recorded speech, as a fourth set of audio signals, from the trainee units to the respective associated interpreter units.

4. The conference system as claimed in claim 2, wherein the central unit is further configured to, in a training mode, allow distribution of locally captured speech signals, as a fifth set of audio signals, from the interpreter units to the respective associated trainee units, and wherein the trainee units, furthermore, are provided with recording means to record the pre-recorded speech, together with the speech signal captured locally at the associated interpreter unit.

5. The conference system as claimed in claim 1,
wherein the central unit is further configured to, in a training mode, allow distribution of a speech signal captured by the chairman's unit or by a participant unit, as a fourth set of audio signals, to selected trainee units;
wherein the central unit is further configured to, in the training mode, allow distribution of locally captured speech signals, as a fifth set of audio signals, from the interpreter units to the respective associated trainee units;
and wherein the trainee units, furthermore, are provided with recording means to record the speech signal captured by the chairman's unit or by the participant unit, together with the speech signal captured locally at the associated interpreter unit.

6. The conference system as claimed in claim 4, further provided with cameras associated with the trainee units, wherein the recording means are configured to record, at at least one of the trainee units, a video signal, together with the speech signal captured locally at the associated interpreter unit.

7. The conference system as claimed in claim 1,
wherein the central unit is further configured to, in a training mode, allow distribution of pre-recorded speech, dispatched by the teacher unit or by a trainee unit, as a fourth set of audio signals, to selected interpreter units;
wherein the central unit is further configured to, in the training mode, allow distribution of locally captured speech signals, as a fifth set of audio signals, from the interpreter units to the teacher unit;
and wherein the teacher unit, furthermore, is provided with recording means to record the pre-recorded speech, together with the speech signals locally captured by respective interpreter units.

8. A non-transitory computer program product, comprising code means which are configured to, in the central unit, provide the distribution of the sets of signals as claimed in claim 7.

9. A non-transitory computer program product, comprising code means which are configured to, in the central unit, provide the distribution of the sets of signals as claimed in claim 3.

10. A non-transitory computer program product, comprising code means which are configured to, in the central unit, provide the distribution of the sets of signals as claimed in claim 4.

11. A non-transitory computer program product, comprising code means which are configured to, in the central unit, provide the distribution of the sets of signals as claimed in claim 5.

12. A non-transitory computer program product, comprising code means which are configured to, in the central unit, provide the distribution of the sets of signals as claimed in claim 6.

13. A non-transitory computer program product, comprising code means which are configured to, in the central unit, provide the distribution of the sets of signals as claimed in claim 7.

14. The conference system as claimed in claim 3, wherein the central unit is further configured to, in a training mode, allow distribution of locally captured speech signals, as a fifth set of audio signals, from the interpreter units to the respective associated trainee units, and wherein the trainee units, furthermore, are provided with recording means to record the pre-recorded speech, together with the speech signal captured locally at the associated interpreter unit.

15. The conference system as claimed in claim 5, further provided with cameras associated with the trainee units, wherein the recording means are configured to record, at at least one of the trainee units, a video signal, together with the speech signal captured locally at the associated interpreter unit.
